(19) United States
(12) Patent Application Publication
(10) Pub. No.: US 2010/0029423 A1
(43) Pub. Date: Feb. 4, 2010

(54) TENSIONING DEVICE FOR A TRACTION MECHANISM DRIVE

(75) Inventors: Rainer Pflug, Heilsbronn (DE); Bernd Hartmann, Weisendorf (DE); Thorsten Liebel, Furth (DE); Scott Thompson, Warren, MI (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/519,368

(22) PCT Filed: Nov. 14, 2007
(86) PCT No.: PCT/EP2007/062308

§ 371 Date: Jun. 16, 2009

(30) Foreign Application Priority Data
Dec. 16, 2006 (DE) 102006059550.5

(51) Int. Cl. F16H 7/12; F16H 7/08

(52) U.S. Cl. 474/101

(57) ABSTRACT

A tensioning device for a traction mechanism drive, in particular for a belt drive. The tensioning device can be produced in an advantageous manner from production and design aspects and which offers advantages over known concepts with regard to the wear of the friction surface element in that it has a base part, having a pivot arm, having a torsion spring, which is designed as a coil spring, for imparting a pivoting torque which acts between the base part and the pivot arm and which forces the pivot arm in a tensioning direction, and having a damping device for generating a damping force which counteracts a pivoting movement of the pivot arm counter to the tensioning direction. The damping device includes a friction surface element which, as such, forms a friction surface which serves to impart a friction force, and which is seated on a mating friction surface, wherein the friction surface element is designed as a ring-shaped or ring-segment-shaped component and is forced outward, in a radial direction with respect to the pivot axis, against the mating friction surface by the torsion spring, and wherein the torsion spring has a coil end section which bears against an inner surface of the friction surface element. The torsion spring is designed, at least in the coil end section which bears against the inner surface of the friction surface element, with regard to the spring cross section such that said coil end section is in areal contact with the inner surface of the friction surface element.

### BACKGROUND

The invention is directed to a tensioning device for a traction mechanism, in particular, for a belt drive that is incorporated as such in an internal combustion engine, in order to drive components of the engine or installed assemblies, such as, for example, injection pumps, steering-booster pumps, generators, water pumps, air-conditioner compressors, or comparable units.

From DE 35 46 901 C2, a belt-tensioning device is known that has a mounting block and a pivot arm mounted so that it can pivot on this block. This belt-tensioning device further comprises a torsion spring that generates a torque acting between the mounting block and the pivot arm. Using this torque it is possible to press a tensioning roller mounted on the pivot arm against a belt section, typically, a return section of the belt drive, and in this way to maintain a tension on the belt that is sufficient for maintaining the friction-fit coupling of the disks of the belt drive. Furthermore, between the mounting block and the pivot arm, a brake device is active by which the movement of the pivot arm can be braked through Coulomb friction by which belt vibrations are damped.

From DE 101 31 916 A1 a tensioning device, in particular, a belt-tensioning device is also known for a traction mechanism. This tensioning device also comprises a mounting structure and a pivot arm that is mounted so that it can move on this structure and that is provided with a tensioning roller. The pivoting motion between the pivot arm and the base structure is damped by a bushing element that is inserted into the inner section of a coil spring acting as a restoring spring and that provides, as such, friction contact surfaces.

From DE 10 2004 047 422 and also the corresponding EP 1 640 636 A2, a tensioning device is known in which the restoring spring is constructed as a leg-less coil spring. This coil spring has a coil end section that enters into a contact ring and that applies a force on this ring in the radial direction. Through this contact ring, a damping bushing is forced outward in the radial direction against a contact surface.

### SUMMARY

The invention is based on the object of creating a tensioning device that can be produced advantageously with respect to production-specific and construction-specific aspects and that offers advantages relative to known concepts with respect to the wear of the friction surface element.

The objective noted above is met according to the invention by a tensioning device with a base part, a pivot arm, a torsion spring constructed as a coil spring for applying a pivot moment that acts between the base part and the pivot arm and that forces the pivot arm in the tensioning direction, and a damping device for generating a damping force that acts against a pivoting motion of the pivot arm acting against the tensioning direction, wherein the damping device comprises at least one friction surface element forming, as such, a friction surface that is used for applying a friction force and that sits on a mating friction surface, wherein the friction surface element is constructed as a ring-shaped or ring segment-shaped component and is forced by the torsion spring in a direction that is radial to the pivoting axis outward against the mating friction surface, and wherein the torsion spring has a coil end section bearing against an inner surface of the friction surface element, wherein this tensioning device is distinguished in that the torsion spring is constructed at least in the coil end section bearing against the inner surface of the friction surface element with respect to the spring cross section such that each coil end section contacts the inner surface of the friction surface element across a surface area.

In this way it is advantageously possible to create a tensioning device for a traction mechanism that can be realized, as a whole, as a relatively compact assembly and that is distinguished by an advantageous mechanical operating behavior that can be guaranteed reliably over a long operating time period. The tensioning device can also comprise, in an especially advantageous way, several, in particular, two friction surface elements.

According to one especially preferred embodiment of the invention, the friction surface element and the torsion spring are constructed in the region of the coil end section such that the cross-sectional edge adjacent to the friction surface element contacts the cross-sectional edge defined by the inner surface in an axial sectional plane containing the pivot axis. These cross-sectional edges are here constructed advantageously so that they have essentially parallel profiles relative to each other, wherein the contact distance of these cross-sectional edges equals advantageously at least approximately 30% of the thickness of the coil material measured in the axial direction of the torsion spring.

According to one especially preferred embodiment of the invention, the torsion spring is made from a spring wire, in particular, a steel wire whose cross section is shaped so that this defines a flat side wherein this spring wire is wound relative to the torsion spring such that this flat side comes to lie in the coil outer section and thus can contact the friction surface element across a surface area. A correspondingly shaped torsion spring can be produced, in particular, in that this is wound from a spring wire with an essentially rectangular cross section. The longitudinal edges of this spring wire are advantageously rounded.

The friction surface element is advantageously made from a plastic material. This plastic material can be loaded, in particular, with strength-increasing additives, as well as also additives that increase the friction behavior and also the abrasion resistance of the friction surface element. The friction surface element can also be made in an especially advantageous way as multiple components, in particular, a composite component. In particular, the friction surface element could be constructed as a ring made from two different types of plastics with the goal of high strength in the region of the spring contact, e.g., through reinforced plastic and also good damping properties in the friction section through the addition of dry lubricants. The friction surface element could be constructed, in particular, as a ring made from a steel-plastic composite body. In particular, in the region of the spring-friction ring contact, a metal, in particular, steel belt could also be placed, in order to increase the permissible loading. In the region of the contact zone between the ring and housing, the plastic or plastic compound named above could be provided.

The friction surface element could be constructed as a relatively complex structure component and in this way could have, in particular, a catch section by which the friction surface element could be locked in rotation either with the base part or optionally also with the pivot arm. On each catch section there could be a support surface that is used as such for supporting an end surface of the coil end section. Furthermore, it is possible to form, in the inner section of the friction surface element, a support structure that is formed as a spiral ramp and that is used, as such, for the axial support of the torsion spring at least in the region of the last spring coil.

### BRIEF DESCRIPTION OF THE DRAWINGS

Additional details and features of the invention emerge from the following description in connection with the drawing. Shown are:

FIG. 1 is an axial section view of a tensioning device according to the invention illustrating the construction of this device,

FIG. 2 is a schematic diagram illustrating the distribution of the prevailing radial forces in the region of the friction surface of the friction surface element,

FIG. 3 is a diagram illustrating the cross sections of the friction surface element and the torsion spring.

### DETAILED DESCRIPTION OF THE PREFERRED EMBODIMENTS

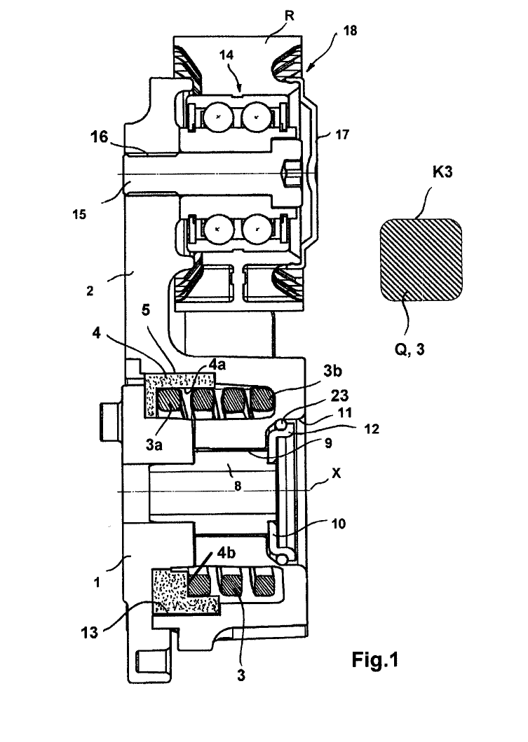

The tensioning device shown in FIG. 1 is used as such for applying a tensioning force that tensions a belt section onto a tensioning roller R. The tensioning device comprises a base part 1, a pivot arm 2, and a torsion spring 3 that is used, as such, for applying a pivot moment that acts between the base part 1 and the pivot arm 2 and that forces the pivot arm 2 in a tensioning direction.

The torsion spring 3 is constructed in this embodiment as a leg-less cylinder spring. The torsion spring 3 is supported in the region of an end section 3a facing the base part 1 on contours formed in the base part 1. The second spring end 3b facing away from the spring leg 3a is anchored on the pivot arm 2.

The tensioning device according to the invention comprises a damping device that is used as such for generating a damping force and that generates, in particular, a friction moment directed opposite a pivoting motion of the pivot arm about the pivot axis X against the tensioning direction.

The damping device comprises a friction surface element 4. The friction surface element 4 comprises, in turn, a friction surface 5 that is used for applying a friction force and that sits on a mating friction surface 13. The friction surface element 4 is constructed in this embodiment as a ring-shaped or at least ring segment-shaped component. The tensioning device shown here is distinguished in that the torsion spring 3 has a coil end section 3a bearing from the inside against an inner surface 4a of the friction surface element 4, wherein the torsion spring 3 is constructed at least in the coil end section 3a bearing against the inner surface 4a of the friction surface element 4 with respect to the spring cross section Q such that the coil end section 3a contacts the inner surface 4a of the friction surface element 4 across a surface area. The specification “contacts across a surface area” is to be understood in the present context as a contact between two contact surfaces of the spring device 3 and the friction surface element 4, wherein these contact surfaces have curved profiles that are equal or, to a large extent, similar in an axial plane containing the pivot axis X.

The pivoting support of the pivot arm 2 on the base part 1 is realized by a pivot journal 8 that is anchored in the base part 1 and defines an outer peripheral surface on which the pivot arm 2 sits via a sliding bearing bushing 9. A cover ring 10 is fixed on the pivot journal 8. The cover ring 10 sits in a recess 11 of the pivot arm 2 and is also provided with a holding bead 12 by means of which a sealing element 13 is guided. A movement gap defined between the cover ring 10 and the inner peripheral surface of the recess 11 is sealed by the sealing element 23.

In this embodiment, the track roller R is made from a plastic material and sits, via a roller bearing device 14, on a threaded bolt 15 that is anchored by a threaded section 16 in the pivot arm 2. In a side section facing away from the anchoring section of the screw bolt 15, the tensioning roller R is provided with a cover cap 17 through which the roller bearing device 14 and also the entire front attachment section are completely covered. The cover cap 17 is anchored by a snap-ring edge 18 on the tensioning roller R.

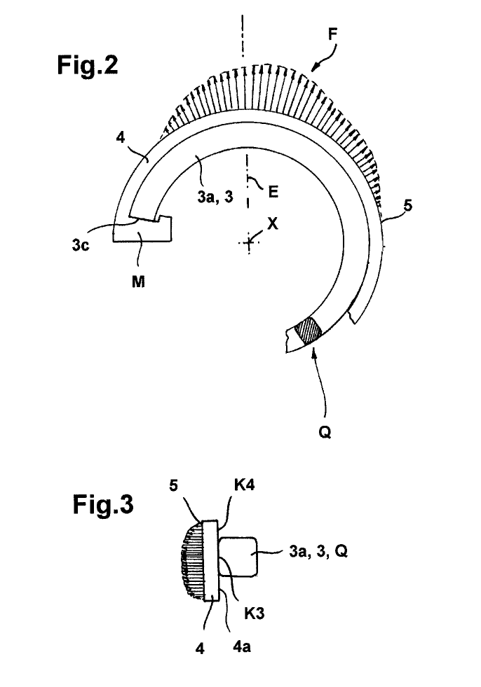

In FIG. 2, in the form of a schematic diagram, the application of force on the friction surface element 4 is shown with a force generated by the spring coil section 3a and running in the radial direction relative to the pivot axis X. By loading the friction surface element 4 by the spring end section 3a, in the outer section of the friction surface element 4, i.e., in the region of the friction surface 5 formed by the friction surface element 4, the friction force distribution F distributed here is produced. The coil section 3a extends up to an end face 3c. This end face 3c is supported on a catch section M of the friction surface element 4. The friction surface element 4 is anchored by the catch section M on catch contours that are not shown in more detail here and that are provided by the base part 1 in the embodiment according to FIG. 1. The torsion spring device 3 and the friction surface element 4 are shaped so that, in the axial plane E shown here, the cross sections shown simplified in FIG. 3 are produced.

As is visible from FIG. 3, the torsion spring device 3 is shaped such that this has an essentially rectangular cross section Q at least in the region of the coil end section 3a. This cross section Q is limited by a contact edge K3 that forms a close, surface-area contact on the inner surface 4a of the friction surface element 4 in the view shown here. The friction surface element 4 is shaped in the embodiment shown here such that this also has a rectangular cross section that is limited in the region of the inner surface 4a by a cross-sectional edge K4. Through the affected shape of the contact surfaces of the torsion spring device 3 and the friction surface element 4, a uniform introduction distributed across a surface area of the radial forces applied by the torsion spring device 3 into the friction surface element 4 is guaranteed. In this way, a favorable distribution of the radial forces acting here on the mating friction surface 13 is also produced in the region of the friction surface 5.

### LIST OF REFERENCE SYMBOLS

1 Base part
2 Pivot arm
3 Torsion spring
3a End section
3b Spring end
3c End face
4 Friction surface element
4b Spiral ramp
5 Friction surface
8 Pivot journal
9 Sliding bearing bushing
10 Cover ring
11 Recess
12 Holding bead
13 Mating friction surface
14 Roller bearing device
15 Screw bolt
17 Cover cap
18 Snap-ring edge
23 Sealing element
R Track roller
F Friction force distribution
K3 Contact edge
K4 Cross-sectional edge
M Catch section
Q Cross section
X Pivot axis

1. Tensioning device comprising:
a base part,
a pivot arm,
a torsion spring constructed as a coil spring for applying a pivot torque that acts between the base part and the pivot arm and that forces the pivot arm in a tensioning direction, and
a damping device for generating a damping force that acts against a pivoting of the pivot arm directed against the tensioning direction,
the damping device comprises at least one friction surface element that includes a friction surface that is used for applying a friction force and that sits on a mating friction surface,
the friction surface element is constructed as a ring-shaped or ring segment-shaped component and is forced by the torsion spring in a direction radial to the pivot axis outward against the mating friction surface, and the torsion spring has a coil end section bearing against an inner surface of the friction surface element,
the torsion spring is constructed at least in a coil end section bearing against an inner surface of the friction surface element with respect to the spring cross section such that the coil end section contacts the inner surface of the friction surface element across a surface area.

2. Tensioning device according to claim 1, wherein the friction surface element and the torsion spring are constructed in a region of the coil end section such that, in a section plane axial to the pivot axis, a cross-sectional edge adjacent to the friction surface element runs along a cross-sectional edge defined by the inner surface.

3. Tensioning device according to claim 2, wherein the torsion spring is made from a spring wire with a cross section that defines at least one flat side, and the spring wire is wound such that the flat side comes to lie in a coil outer section.

4. Tensioning device according to claim 3, wherein the torsion spring is made from a spring wire with an essentially rectangular cross section.

5. Tensioning device according to claim 4, wherein longitudinal edges of the spring wire are rounded.

6. Tensioning device according to claim 1, wherein the at least one friction surface element is produced from a plastic material.

7. Tensioning device according to claim 1, wherein at least one of the at least one friction surface elements is provided with a catch section.

8. Tensioning device according to claim 7, wherein the catch section forms a support surface for supporting an end face of the coil end section.

9. Tensioning device according to claim 1, wherein in an inner section of the friction surface element, a spiral ramp is constructed for axial support of the torsion spring in a region of a last spring coil at the coil end section.

10. Tensioning device according to claim 1, wherein at least one of the at least one friction surface elements is made from a plastic material with reinforcement additives that improve wear resistance and friction properties.

11. Tensioning device according to claim 1, wherein at least one of the at least one friction surface elements is formed as multiple components or as a compound component and a steel-plate insert is provided in a contact section of the spring device on the friction surface element.

12. Tensioning device according to claim 1, wherein a peripheral curve of the end section of the spring device contacting the friction surface element is adjusted so that a uniform surface pressure distribution is produced.

13. Tensioning device according to claim 1, wherein a peripheral curve of an inner peripheral surface of the friction surface element contacting the end section of the spring device is adjusted such that a uniform surface pressure distribution is produced.

14. Tensioning device according to claim 1, wherein the spring device is made from two spring coils screwed one in the other.

15. Tensioning device according to claim 14, wherein the two spring coils are joined to each other such that ends opened to a corresponding end face of the spring coil are diametrically opposite to each other with respect to a spring longitudinal axis.

16. Tensioning device according to claim 1, wherein the spring device and the friction surface element are constructed such that the friction surface element is contacted in a region of an inner peripheral surface thereof at least by two or more axially successive coils of the spring coil.
